(19) United States
(12) Patent Application Publication
(10) Pub. No.: US 2012/0293897 A1
(43) Pub. Date: Nov. 22, 2012

(54) CONNECTOR WITH VOLTAGE PROTECTION FUNCTION

(76) Inventors: Dong-Lai ZHU, Jiangsu (CN); Quan HE, Jiangsu (CN); Jian-Ming MAO, Jiangsu (CN)

(21) Appl. No.: 13/467,793

(22) Filed: May 9, 2012

(30) Foreign Application Priority Data
May 20, 2011 (CN) 201110131714.2

(51) Int. Cl. H02H 9/00

(52) U.S. Cl. 361/56

(57) ABSTRACT

A connector with a voltage protection function is to be electrically connected to a power supply device which provides a plurality of power voltages. The connector includes a main body, a plurality of pins and a voltage protection circuit module. The pins disposed on the main body are connected to the power voltages provided by the power supply device. The voltage protection circuit module includes a plurality of input terminals electrically connected to the power voltages. When a value of one of the power voltages exceeds a predetermined range, the voltage protection circuit module grounds at least one of the power voltages.

### CROSS REFERENCE TO RELATED APPLICATIONS

This Non-provisional application claims priority under 35 U.S.C. §119(a) on Patent Application No(s). 201110131714.2 filed in People's Republic of China on May 20, 2011, the entire contents of which are hereby incorporated by reference.

### BACKGROUND OF THE INVENTION

1. Field of Invention

The invention relates to a connection device, and more particularly to a connector with the enhanced safety performance.

2. Related Art

As the electronic product is developed to have the diversified functions and the gradually enhanced performance, various electronic elements inside the electronic product become more and more precise, and all the electronic elements require the stable power voltage to work normally.

A power supply connector is electrically connected to a mainboard of the electronic device by way of insertion, and the mainboard is coupled to a power supply device through a connector. The power supply device provides various power voltages, including 3.3V, 5V, 12V and the like, to the mainboard through the power supply connector, thereby providing the power voltages to various electronic elements.

However, if the computer is used in an area with the unstable supplied voltage, the power voltage supplied to the power supply device of the computer is unstable, thereby causing the electronic elements on the mainboard to damage or fail.

### SUMMARY OF THE INVENTION

The invention discloses a connector having a voltage protection function and configured for electrically connecting to a power supply device providing a plurality of power voltages. The connector comprises a main body, a plurality of pins and a voltage protection circuit module. The pins are disposed on the main body and configured for connecting to the power voltages provided by the power supply device. The voltage protection circuit module comprises a plurality of input terminals to be electrically connected to the power voltages. When a value of one of the power voltages exceeds a predetermined range, the voltage protection circuit module grounds at least one of the power voltages.

The invention also discloses a mainboard to be electrically connected to a power supply device providing a plurality of power voltages. The mainboard comprises a first circuit board and a connector disposed on the first circuit board. The connector comprises a main body, a plurality of pins and a voltage protection circuit module. The pins are disposed on the main body and configured for connecting to the power voltages. The pins are electrically connected to the first circuit board. The voltage protection circuit module comprises a plurality of input terminals to be electrically connected to the power voltages. When a value of one of the power voltages exceeds a predetermined range, the voltage protection circuit module grounds at least one of the power voltages.

In summary, the connector disclosed in this invention includes the voltage protection circuit module for grounding the power voltage and thus protecting the elements on the mainboard when the power voltage provided by the power supply device exceeds the predetermined value. The voltage protection circuit module of the connector can be integrated with the main body or the mainboard. Thus, when the voltage protection circuit module is integrated with the connector, no voltage protection circuit module of the power supply connector has to be designed on the mainboard. In addition, the voltage protection circuit module can be disposed on the side surface of the connector, and thus save the space of the mainboard.

These and other features, aspects and advantages of the present invention will become better understood with regard to the following description, appended claims, and accompanying drawings.

### BRIEF DESCRIPTION OF THE DRAWINGS

FIG. 1A is a schematic illustration showing a structure of a connector to be electrically connected to a mainboard by way of insertion;

FIG. 1B is a schematic illustration showing the definitions of pins of the connector of FIG. 1A;

FIG. 2 is a schematic illustration showing a structure of a mainboard on which a connector with a protection function is disposed by way of insertion according to an embodiment;

FIG. 3 is a schematic illustration showing a structure of the connector with the protection function according to the embodiment;

FIG. 4 is a block diagram showing the mainboard and the connector with the protection function according to the embodiment;

FIG. 5 is a circuit diagram showing a voltage protection circuit module of the connector according to the embodiment; and

FIGS. 6A to 6C are block diagrams showing modified voltage protection circuit modules of the connector according to modified embodiments.

### DETAILED DESCRIPTION OF THE INVENTION

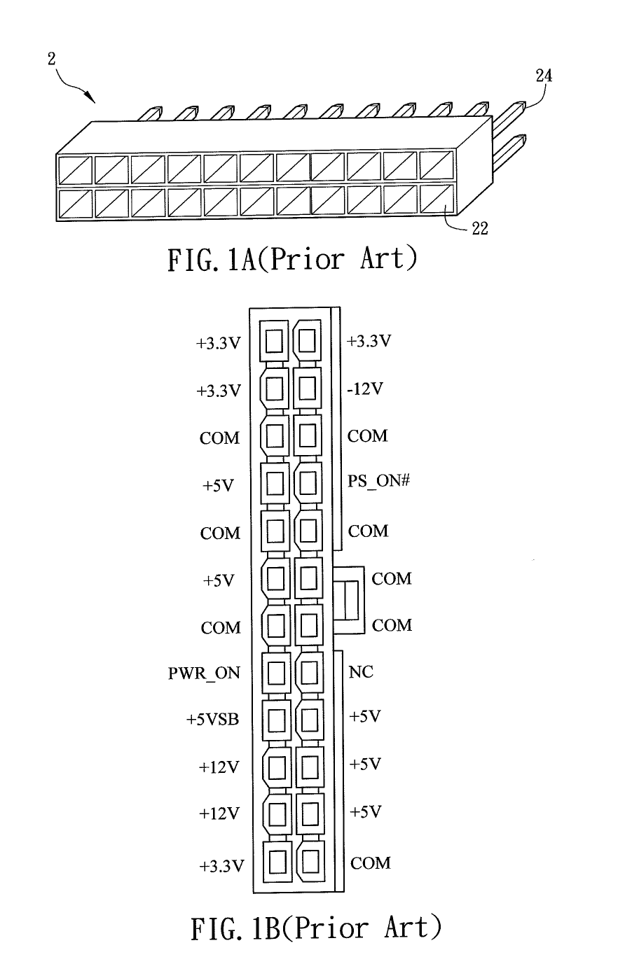

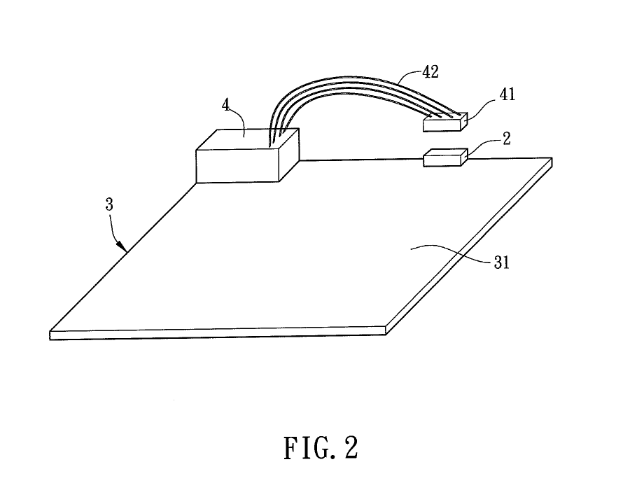

FIG. 1A is a schematic illustration showing a structure of a connector 2 to be electrically connected to a mainboard by way of insertion. FIG. 1B is a schematic illustration showing the definitions of pins of the connector 2 of FIG. 1A. Please refer to FIGS. 1A and 1B simultaneously.

The connector 2 in FIG. 1A has 24 pins. However, those skilled in the art may understand that the invention does not intend to limit the model of the power supply connector, and the concept of the invention can be adapted to another power supply connector with 4/20/24 pins or any other number of pins.

The connector 2 is to be connected to a power supply device. The connector 2 includes connection holes 22 and pins 24 disposed correspondingly to the connection holes 22, respectively. The connection head of the power supply device is correspondingly inserted into the connection holes 22 and then electrically connected to the pins 24, so that the output voltage of the power supply device is provided to the mainboard through the connector 2.

The definition of each pin 24 is shown in FIG. 1B. The connector 2 receives the standby power voltages of +3.3V, +5V, +5V, and the power voltage of ±12V or the like to be inputted to the mainboard. Meanwhile, the connector 2 also provides a ground source.

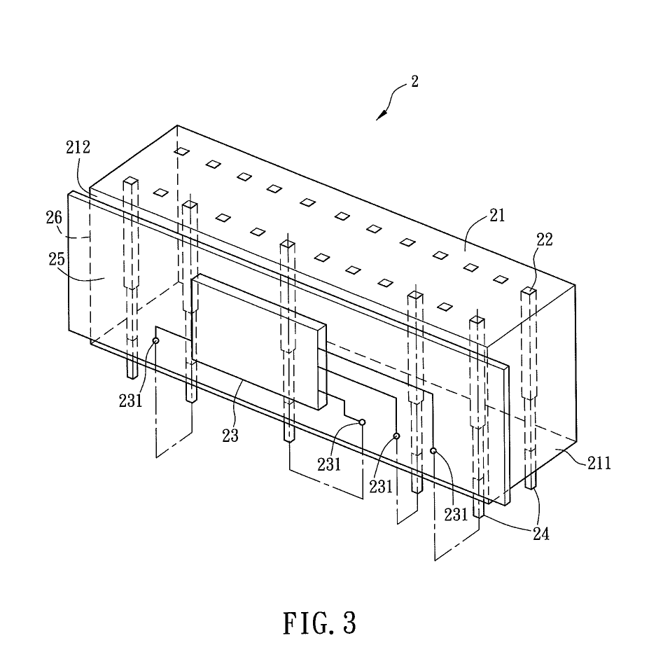

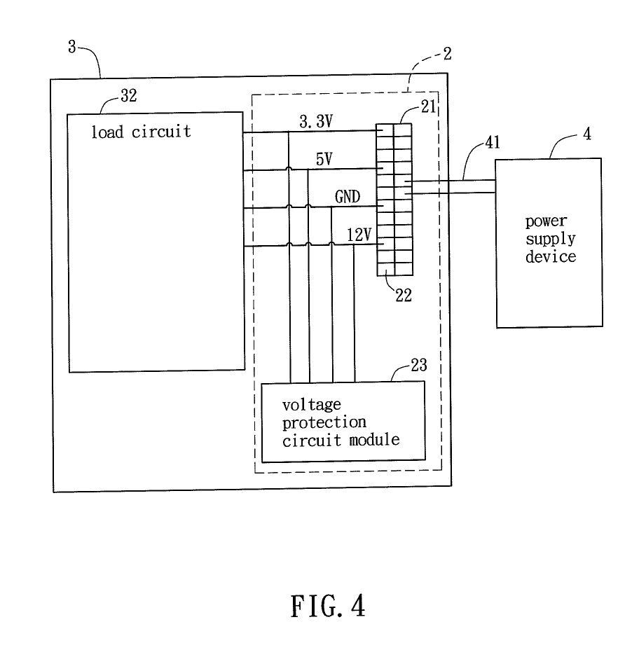

FIG. 2 is a schematic illustration showing a structure of a mainboard 3 on which a connector with a protection function is disposed by way of insertion according to an embodiment. FIG. 3 is a schematic illustration showing a structure of the connector 2 with the protection function according to the embodiment. Please refer to FIGS. 2 and 3 simultaneously.

A power supply device 4 includes a connection head 41 and a power transmission cable 42 for transmitting a plurality of power voltages provided by the power supply device 4. In the following embodiment, the connection head 41 is described as an example, and can be connected to the connection head of the connector 2 in FIGS. 1A and 1B.

The mainboard 3 includes a first circuit board 31 and a connector 2 electrically connected to the first circuit board 31. The connector 2 includes a plurality of connection holes 22 to be connected to the connection head 41 and electrically connected to a plurality of power voltages.

In this embodiment, the power supply device 4 is disposed on the first circuit board 31. In addition, the power supply device 4 may also be independent of the mainboard 3. For example, the power supply device 4 is disposed in a casing of a computing device, while the mainboard 3 is also disposed in the casing of the computing device.

The connector 2 includes a main body 21, a plurality of pins 24, a plurality of connection holes 22 and a voltage protection circuit module 23. The main body 21 is disposed on the first circuit board 31 of the mainboard 3. The connection holes 22 are connected to the power supply device 4 and for accommodating pins (not shown) on the connection head 41 of the power supply device 4. The pins 24 disposed on the main body 21 of the connector 2 are connected to power voltages provided by the power supply device 4. In one embodiment, the definitions of the pins 24 may be the same as those of the pins of FIG. 1B.

The main body 21 includes a first surface 211 and a second surface 212. In one embodiment, the first surface 211 and the second surface 212 neighbor each other but are not disposed on the same plane.

The pins 24 disposed on the first surface 211 are to be inserted into or bonded to the first circuit board 31 of the mainboard 3. The pins 24 are disposed correspondingly to the connection holes 22. When the pins (not shown) of the connection head 41 of the power supply device 4 are connected to the connection holes 22, the power voltages are inputted to the mainboard 3 through the pins 24.

In this embodiment, the voltage protection circuit module 23, which is integrated with the main body 21 of the connector and is disposed on the second surface 212 of the main body 21, provides the voltage protection function. Because the voltage protection circuit module 23 needs not to be designed and disposed on the first circuit board 31 of the mainboard 3, the space occupied by the first circuit board 31 can be reduced.

In this embodiment, the connector 2 may further include a second circuit board 25, and the voltage protection circuit module 23 and a portion of the input terminals 231 (the other portion of the input terminals 231 pass through the main body 21 and are disposed correspondingly to the connection head) which are disposed on the second circuit board 25.

The connector 2 may further include a fixing device 26, through which the second circuit board 25 is fixed onto the second surface 212 of the main body 21.

The fixing device 26 may include an adhesive, an engaging structure or a magnetic element. The second circuit board 25 may be fixed onto the second surface 212 by way of, without limitation to, adhering, engaging or magnetic attracting.

The voltage protection circuit module 23 includes a plurality of input terminals 231 electrically connected to the power voltages, respectively. The input terminals 231 may be disposed in the connection holes 22, and may also be electrically connected to the pins 24 as long as the input terminals 231 are located such that they can be electrically connected to the connection head 41 of the power supply device 4. Those skilled in the art may modify the locations of the input terminals according to the design requirements.

The voltage protection circuit module 23 is not necessary to be disposed outside the first surface 211 and the second surface 212 of the main body 21 of the connector. The designer can dispose the voltage protection circuit module inside the main body 21 according to the requirements.

The voltage protection circuit module 23 is electrically connected to the input terminals 231. When a value of one of the power voltages inputted into the input terminals 231 exceeds a predetermined range (when the voltage value of the power voltage is too high or too low), the voltage protection circuit module 23 grounds at least one of the power voltages (e.g., the power voltage exceeding the predetermined range) to prevent it from entering the mainboard 3 and damaging the elements in the mainboard 3.

The predetermined value of the predetermined range is set according to the power voltage connected to each input terminal 231. When the input terminal 231 is connected to the 5V power voltage, the predetermined value is set as 5V. The predetermined range means the floating range of the predetermined value. Of course, the predetermined range may be set by the designer and is not restricted to ±20% fluctuating about the predetermined value. According to the requirements, the predetermined range may be set as ±5%, ±10%, ±30% or the like fluctuating about the predetermined value.

Once the power voltage connected to the input terminal 231 exceeds the predetermined range (±20% fluctuating about 5V), the voltage protection circuit module 23 grounds the power voltage.

The power voltage grounding is to make the power voltage, provided by the power supply device, and the ground source become short-circuited to enable the power supply device to perform the self protection and turn off the power.

In the voltage protection circuit module 23, a silicon controlled rectifier (SCR) may be adopted to perform the control. For example, the voltage protection circuit module 23 includes a comparator and a controller. Each power voltage is connected to the comparator. The comparator compares the connected power voltage with the predetermined value. When the power voltage exceeds the predetermined range, the comparator outputs a signal to the controller, which electrically connects the power voltage to the ground.

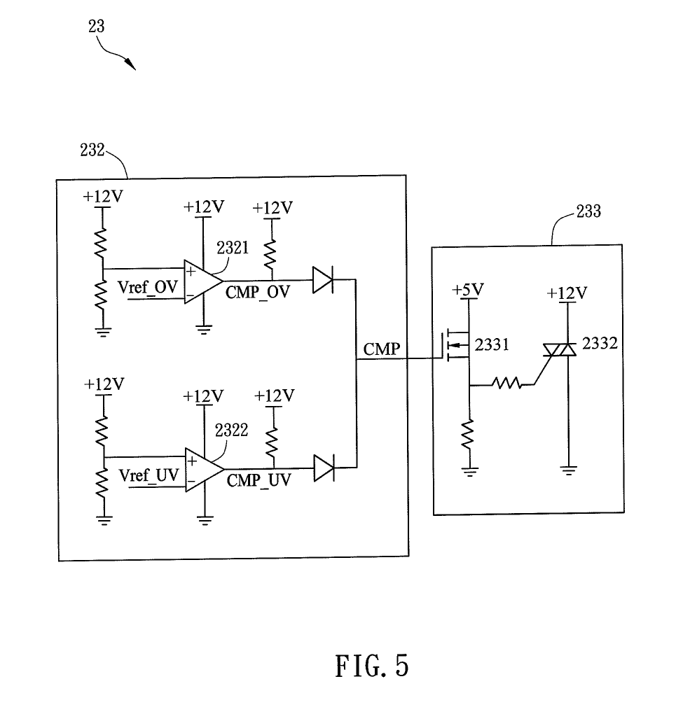

As shown in FIG. 4, the voltage protection circuit module 23 and a load circuit 32 of the mainboard 3 are connected in parallel and between the power supply device 4 and the ground GND. The ground GND is electrically connected to the ground source of the power supply device 4. The power supply device 4 provides the power to the load circuit 32. The load circuit 32 is a general designation of electronic elements on the mainboard 3 and includes various kinds of electronic elements, such as resistors, capacitors, inductors, semiconductor chips and the like, disposed on the mainboard 3. The semiconductor chip includes a digital logic chip, a memory, a processor, a system chipset or the like.

In addition, the voltage protection circuit module 23 may also be integrated with the first circuit board 31 of the mainboard 3. The traces of the voltage protection circuit module 23 may be formed on a circuit layer of the first circuit board 31 by way of drawing or printing. The electronic elements of the voltage protection circuit module 23 are disposed on the first circuit board 31 and connected to the traces of the first circuit board 31.

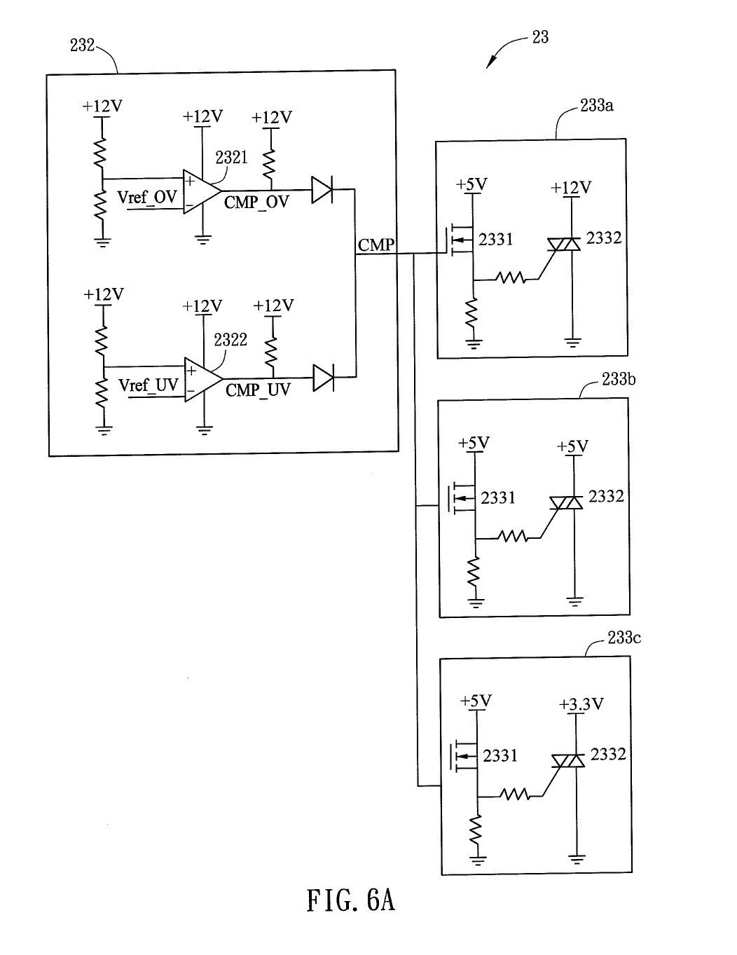

Referring to FIG. 5, the voltage protection circuit module 23 includes at least one comparison unit 232 and at least one ground unit 233. The comparison unit 232 outputs a comparison signal CMP after comparing one of the power voltages (12V) with the predetermined range. The ground unit 233 grounds the power voltage (12V) according to the comparison signal CMP. The comparison unit 232 and the ground unit 233 are electrically connected to the power voltage (12V) through the input terminal 231 (see FIG. 3).

The predetermined range ranges between a first reference voltage Vref_OV and a second reference voltage Vref_UV. The comparison unit 232 includes at least one comparator. At least one of the first reference voltage Vref_OV and the second reference voltage Vref_UV and one of the power voltages are electrically connected to two input terminals of the comparator, respectively, and an output terminal of the comparator outputs the comparison signal.

In this embodiment, the comparison unit 232 includes a first comparator 2321 and a second comparator 2322. The first reference voltage Vref_OV and the power voltage (12V) are electrically connected to two input terminals of the first comparator 2321. When the power voltage (12V) is higher than the first reference voltage Vref_OV, the output terminal of the first comparator 2321 outputs a first comparison signal CMP_OV with a high voltage level. The second reference voltage Vref_UV and the power voltage (12V) are electrically connected to two input terminals of the second comparator 2322, respectively. When the power voltage (12V) is lower than the second reference voltage Vref_UV, the output terminal of the second comparator 2322 outputs a second comparison signal CMP_UV with the high voltage level. The first comparison signal CMP_OV or the second comparison signal CMP_UOV having the high voltage level serves as the comparison signal CMP outputted from the comparison unit 232.

The first reference voltage Vref_OV and the second reference voltage Vref_UV represent an upper bound and a lower bound of the predetermined range, respectively, and the values thereof may be set by the designer. The first reference voltage Vref_OV may be, for example, +20% of the predetermined power voltage, and may be set as +5%, +10% or +30% of the predetermined power voltage or the like according to the requirements. Similarly, the second reference voltage Vref_UV may be, for example, −20% of the predetermined power voltage, and may be set as −5%, −10% or −30% of the predetermined power voltage or the like according to the requirements.

The first comparator 2321 and the second comparator 2322 detect the upper bound and the lower bound of the predetermined range of voltage, respectively. However, the comparison unit 232 may contain only one comparator, which may be configured to detect only the upper bound or the lower bound of the predetermined range of voltage.

The ground unit 233 electrically connected to the comparison unit 232 grounds the power voltage (12V) monitored by the comparison unit 232, and includes a control switch 2331 and a short-circuit element 2332. The comparison signal CMP turns on the control switch 2331 to control the short-circuit element 2332 to ground the power voltage (12V).

In this embodiment, the control switch 2331 is a metal-oxide-semiconductor field-effect transistor (MOSFET), and the short-circuit element 2332 is a silicon controlled rectifier (SCR). Of course, the control switch 2331 may also be selected from other types of transistors. Similarly, the short-circuit element 2332 is not restricted thereto, and may also be a transistor, which serves as a switch and is controlled by the control switch 2331 to determine whether to couple the power voltage to the ground or not.

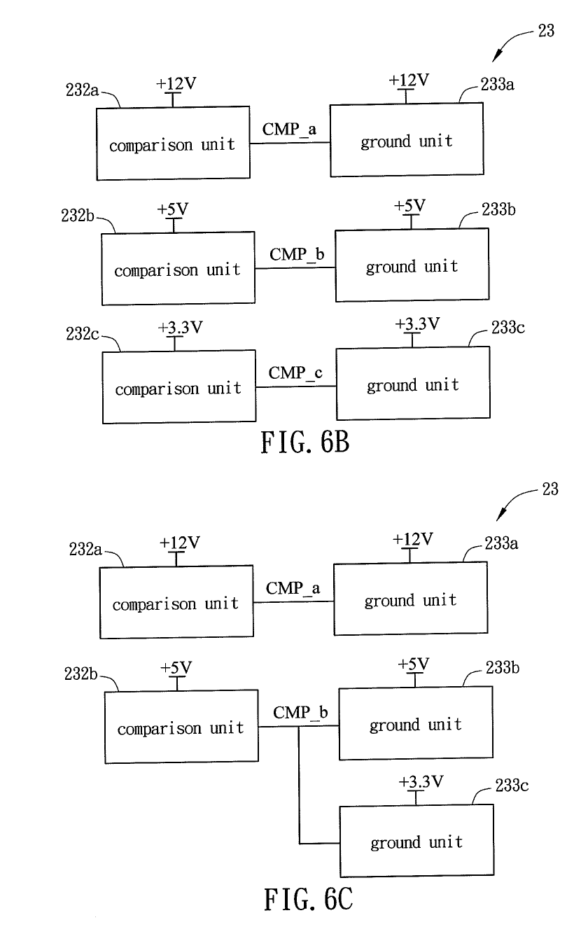

FIGS. 6A to 6C show modified aspects of the voltage protection circuit module 23. Referring to FIG. 6A, the voltage protection circuit module 23 includes a comparison unit 232 and a plurality of ground units 233a to 233c. The comparison unit 232 detects whether the value of one power voltage (e.g., 12V) exceeds the predetermined range, the ground units 233a to 233c are electrically connected to the comparison unit 232, and ground the power voltages (3.3V, 5V, 12V) according to the comparison signal CMP outputted from the comparison unit 232, respectively. When the power voltage (12V) is abnormal, the ground units 233a to 233c ground all the power voltages (3.3V, 5V, 12V).

In this embodiment, three power voltages are described. However, those skilled in the art may understand that other ground units may be added to ground all the power voltages when the number of the power voltages is greater than 3.

In this embodiment, the difference between the ground units 233a to 233c and the ground unit 233 of the previous embodiment resides in that the power voltages to be short-circuited are different. However, the internal electronic elements and traces of the two embodiments are similar to each other, so detailed descriptions of the ground units 233a to 233c will be omitted.

As shown in FIG. 6B, the voltage protection circuit module 23 has a plurality of comparison units 232a to 232c and a plurality of ground units 233a to 233c corresponding to the comparison units 232a to 232c. The comparison units 232a to 232c detect different power voltages (e.g., 3.3V, 5V, 12V), and the ground units 233a to 233c electrically connected to the comparison units 232a to 232c ground the power voltages (3.3V, 5V, 12V) according to the comparison signals CMP_a to CMP_c outputted from the comparison units 232a to 232c, respectively. When the comparison units 232a to 232c detect the presence of the abnormal conditions, the corresponding ground units 233a to 233c ground the corresponding power voltages (3.3V, 5V, 12V), thereby achieving the function of individually protecting the power voltages (3.3V, 5V, 12V). Because the internal electronic elements and traces of the comparison units 232a to 232c and the ground units 233a to 233c are similar to those of the comparison unit 232 and the ground unit 233, detailed descriptions thereof will be omitted.

As shown in FIG. 6C, the voltage protection circuit module 23 monitors a portion of the power voltages (12V, 5V), but can ground all the power voltages (3.3V, 5V, 12V).

The voltage protection circuit module 23 includes two comparison units 232a and 232b and three ground units 233a to 233c. The comparison units 232a and 232b compare the power voltages (12V, 5V) with the predetermined range, and correspondingly output two comparison signals CMP_a and CMP_b, respectively, when the power voltages (12V, 5V) exceed the predetermined range. The ground units 233a to 233c electrically connected to the comparison units 232a and 232b ground the power voltages (3.3V, 5V, 12V) according to the comparison signals CMP_a and CMP_b.

In detail, the ground unit 233a electrically connected to the comparison unit 232a grounds the power voltage (12V) according to the comparison signal CMP_a outputted from the comparison unit 232a, while the ground units 233b and 233c electrically connected to the comparison unit 232b ground the power voltages (3.3V, 5V) according to the comparison signal CMP_b outputted from the comparison unit 232b.

In summary, the connector disclosed in this invention includes the voltage protection circuit module for grounding the power voltage and thus protecting the elements on the mainboard when the power voltage provided by the power supply device is not equal to the predetermined value. The voltage protection circuit module of the connector can be integrated with the main body or the mainboard. Thus, when the voltage protection circuit module is integrated with the connector, no voltage protection circuit module of the power supply connector has to be designed on the mainboard. In addition, the voltage protection circuit module can be disposed on the side surface of the connector, and thus save the space of the mainboard.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connector, which has a voltage protection function and is to be electrically connected to a power supply device providing a plurality of power voltages, the connector comprising:
a main body;
a plurality of pins disposed on the main body and configured for connecting to the power voltages provided by the power supply device; and
a voltage protection circuit module comprising a plurality of input terminals to be electrically connected to the power voltages, wherein when a value of one of the power voltages exceeds a predetermined range, the voltage protection circuit module grounds at least one of the power voltages.

2. The connector according to claim 1, wherein the main body is disposed on a first circuit board of a mainboard, and the voltage protection circuit module is integrated with the main body or the first circuit board.

3. The connector according to claim 1, wherein the voltage protection circuit module comprises:
at least one comparison unit for comparing one of the power voltages with the predetermined range, and outputting a comparison signal when one of the power voltages exceeds the predetermined range; and
at least one ground unit, which is electrically connected to the comparison unit and for grounding at least one of the power voltages according to the comparison signal.

4. The connector according to claim 3, wherein the predetermined range ranges between a first reference voltage and a second reference voltage.

5. The connector according to claim 4, wherein the comparison unit comprises at least one comparator, at least one of the first reference voltage and the second reference voltage and one of the power voltages are electrically connected to two input terminals of the comparator, respectively, and an output terminal of the comparator outputs the comparison signal.

6. The connector according to claim 3, wherein the ground unit comprises a control switch and a short-circuit element, the comparison signal turns on the control switch to control the short-circuit element to ground the power voltage.

7. The connector according to claim 3, wherein the voltage protection circuit module comprises:
a plurality of ground units, which is electrically connected to the comparison unit and for grounding all the power voltages according to the comparison signal.

8. The connector according to claim 1, wherein the main body comprises a first surface and a second surface, which are not disposed on the same plane and neighbor each other, the pins are disposed on the first surface, and the voltage protection circuit module is disposed on the second surface.

9. The connector according to claim 1, wherein the main body comprises:
a plurality of connection holes disposed correspondingly to the pins and the input terminals and configured for connecting to the power supply device.

10. The connector according to claim 1, further comprising:
a second circuit board, on which the voltage protection circuit module and the input terminals are disposed.

11. A mainboard to be electrically connected to a power supply device providing a plurality of power voltages, the mainboard comprising:
a first circuit board; and
a connector disposed on the first circuit board, the connector comprising:
a main body,
a plurality of pins disposed on the main body and configured for connecting to the power voltages, wherein the pins are electrically connected to the first circuit board, and
a voltage protection circuit module comprising a plurality of input terminals to be electrically connected to the power voltages, wherein when a value of one of the power voltages exceeds a predetermined range, the voltage protection circuit module grounds at least one of the power voltages.

12. The mainboard according to claim 11, wherein the voltage protection circuit module is integrated with the main body or the first circuit board.

13. The mainboard according to claim 11, wherein the voltage protection circuit module comprises:
at least one comparison unit for comparing one of the power voltages with the predetermined range, and outputting a comparison signal when one of the power voltages exceeds the predetermined range; and
at least one ground unit, which is electrically connected to the comparison unit and for grounding at least one of the power voltages according to the comparison signal.

14. The mainboard according to claim 13, wherein the predetermined range ranges between a first reference voltage and a second reference voltage.

15. The mainboard according to claim 14, wherein the comparison unit comprises at least one comparator, at least one of the first reference voltage and the second reference voltage and one of the power voltages are electrically connected to two input terminals of the comparator, respectively, and an output terminal of the comparator outputs the comparison signal.

16. The mainboard according to claim 13, wherein the ground unit comprises a control switch and a short-circuit element, the comparison signal turns on the control switch to control the short-circuit element to ground the power voltage.

17. The mainboard according to claim 13, wherein the voltage protection circuit module comprises:
a plurality of ground units, which is electrically connected to the comparison unit and for grounding all the power voltages according to the comparison signal.

18. The mainboard according to claim 11, wherein the main body comprises a first surface and a second surface, which are not disposed on the same plane and neighbor each other, the pins are disposed on the first surface, and the voltage protection circuit module is disposed on the second surface.

19. The mainboard according to claim 11, wherein the main body comprises:
a plurality of connection holes disposed correspondingly to the pins and the input terminals and configured for connecting to the power supply device.

20. The mainboard according to claim 11, wherein the connector further comprises:
a second circuit board, on which the voltage protection circuit module and the input terminals are disposed.
